(19) United States
(12) Patent Application Publication
(10) Pub. No.: US 2008/0271625 A1
(43) Pub. Date: Nov. 6, 2008

(54) High-Throughput Apparatus for Patterning Flexible Substrates and Method of Using the Same

(75) Inventors: Karan Chauhan, Cambridge, MA (US); Hyung Jun Kim, Cambridge, MA (US); Arthur Yuan Cao, New Jersey City, NJ (US); Brian T. Mayers, Somerville, MA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Nano Terra Inc., Cambridge, MA (US)

(21) Appl. No.: 12/018,029

(22) Filed: Jan. 22, 2008

Related U.S. Application Data
(60) Provisional application No. 60/881,475, filed on Jan. 22, 2007.

(51) Int. Cl. B41F 3/18

(52) U.S. Cl. 101/253

(57) ABSTRACT

The present invention is directed to a high-throughput apparatus for patterning a flexible substrate and methods of using the same.

### CROSS REFERENCE TO RELATED APPLICATIONS

This application claims the benefit of the filing date of U.S. patent application Ser. No. 60/881,475, filed Jan. 22, 2007, which is incorporated herein by reference in its entirety.

### BACKGROUND OF THE INVENTION

1. Field of the Invention

The present invention is directed to a high-throughput apparatus for patterning a flexible substrate and methods of using the same.

2. Background

The patterning of flexible substrates is a growing field that is applicable to diverse industries ranging from electronics to textiles. In addition to traditional screen printing and gravure methods, “soft lithography” processes recently have been developed that enable the formation of ever diminishing surface features rivaling those achievable by optical lithography methods. See, e.g., U.S. Pat. Nos. 5,512,131; 5,900,160; 5,937,758; 6,180,329; and 6,776,094. At the heart of soft lithography is contact between a stamp and a substrate, during which a pattern is transferred from the stamp to the substrate. During further operations in a patterning process the pattern can be used, for example, as an etch resist for etching the substrate, as a mask for the deposition of self-aligned features onto the substrate, or via multiple deposition processes a useful pattern, e.g., an electronic device, can be produced (see, e.g., Ahn et al., “Heterogeneous Three-Dimensional Electronics by Use of Printed Semiconductor Nanomaterials,” Science 314:1754 (2006)).

However, despite its low capital costs, soft lithography has yet to challenge traditional surface patterning methods in the area of patterning flexible substrates. This is partly attributable to past capital investments by manufacturers, but can also be attributed to soft lithography being limited largely to uses in research and development applications. For example, a soft lithography patterning process can include operations such as inking, aligning and contacting that are often performed manually using laboratory tools. Thus, what is needed is a commercial apparatus that can pattern nanometer to centimeter-size features onto flexible substrates in a high-throughput manner using a soft lithography method of contact printing.

### BRIEF SUMMARY OF THE INVENTION

The present invention provides an apparatus for high-throughput patterning of flexible substrates. The methods and apparatus of the present invention employ a stationary stamp adapted to remain rigidly positioned during at least a portion of the patterning process to facilitate transfer of a pattern from the stamp to the flexible substrate in a reproducible manner, with minimized distortion of the pattern, and minimized wear on the stamping surface. Thus, the apparatus and method of the present invention provide an efficient means of large-scale manufacturing. Moreover, the apparatus and methods of the present invention can be readily integrated with other patterning processes for use in a manufacturing setting.

The present invention is directed to an apparatus for patterning a flexible substrate in a continuous manner, the apparatus comprising:
(a) a supply reel adapted to provide a flexible substrate;
(b) a stamp having a surface including at least one indentation therein, the indentation being contiguous with and defining a pattern in the surface of the stamp;
(c) a rigid or semi-rigid member adapted to contact a surface of the flexible substrate parallel to a plane of the surface of the stamp, wherein the stamp is adapted to remain stationary during contact; and
(d) a collector reel adapted to receive the flexible substrate.

The present invention is also directed to an apparatus for patterning a flexible substrate, the apparatus comprising:
(a) a stamp having a surface with at least one indentation therein, the indentation being contiguous with and defining a pattern in the surface;
(b) a flexible substrate adapted to contact the stamp when the flexible substrate is positioned between a supply reel and a collector reel; and
(c) a movable rigid or semi-rigid member adapted to apply a force to a location at a backside of the flexible substrate when the flexible substrate is in contact with the surface of the stamp, and when the stamp is rigidly positioned, to thereby transfer a pattern to the flexible substrate, wherein the pattern in the surface of the stamp defines a lateral dimension of the pattern transferred to the flexible substrate.

In some embodiments, the stamp comprises a plurality of surfaces. The plurality of surfaces on the stamp can comprise identical patterns, or heterogeneous patterns.

In some embodiments, the stamp is provided on a rotatable platform. An axis of rotation of the rotatable platform can be parallel, perpendicular, or skewed relative to a plane of a surface of the stamp.

In some embodiments, the apparatus further comprises: a reactor adapted for exposing a surface of the stamp to a reagent chosen from: radiation, thermal energy, a liquid reagent, a gaseous reagent, a plasma, and combinations thereof.

In some embodiments, the rigid or semi-rigid member comprises two or more independently movable members.

In some embodiments, the stamp is adapted to transfer an ink pattern from the surface of the stamp to a surface of the flexible substrate. In some embodiments, the stamp is adapted to imprint or otherwise transfer a pattern to an ink present on a surface of the flexible substrate.

In some embodiments, the apparatus further comprises: an inking means adapted to apply an ink to at least one of: the surface of the stamp including at least one indentation therein, a surface of the flexible substrate, and combinations thereof.

In some embodiments, the apparatus further comprises: an aligning means adapted to align a location on a surface of the flexible substrate with a location on the surface of the stamp including at least one indentation therein.

The present invention is also directed to a method for patterning a flexible substrate, the method comprising:
(a) providing a stamp having a surface, wherein the surface includes at least one indentation therein, the indentation being contiguous with and defining a pattern in the surface;
(b) contacting a flexible substrate with the surface of the stamp while the flexible substrate is positioned between a supply reel and a collector reel, wherein the surface of the stamp is stationary during the contacting;
(c) applying a force to a location at a backside of the flexible substrate during at least a portion of the contacting between the flexible substrate and the surface of the stamp, wherein applying the force transfers a pattern from the surface of the stamp to a frontside of the flexible substrate, wherein the pattern on the surface of the flexible substrate has a lateral dimension defined by the pattern in the stamp; and
(d) moving the location at which the force is applied to the backside of the flexible substrate.

In some embodiments, the method of the present invention further comprises: before contacting the flexible substrate with the surface of the stamp, pre-treating the surface of the stamp, pre-treating a surface of the flexible substrate, and combinations thereof.

Pre-treating processes suitable for use with the present invention include, but are not limited to, cleaning, oxidizing, reducing, derivatizing, roughening, depositing (e.g., forming a primer or contact layer), functionalizing, exposing a surface to a reactive gas, exposing a surface to a plasma, exposing a surface to thermal energy, exposing a surface to ultraviolet radiation, and combinations thereof

In some embodiments, the method further comprises: applying a tension to at least one of the supply reel, the collector reel, or both to shift the position of the flexible substrate, and repeating operations (b) through (d).

In some embodiments, the method further comprises: aligning a surface of the flexible substrate with the surface of the stamp having at least one indentation therein.

In some embodiments, the method of the present invention further comprises: before contacting the flexible substrate with the surface of the stamp, applying an ink to the surface of the stamp.

In some embodiments, the method of the present invention further comprises: before contacting the flexible substrate with the surface of the stamp, applying an ink to the surface of the flexible material.

In some embodiments, the method of the present invention further comprises: using a rigid or semi-rigid member to apply the force. In some embodiments, the rigid or semi-rigid member comprises a roller. In some embodiments, the rigid or semi-rigid member comprises two or more independently controlled rigid or semi-rigid members.

In some embodiments, the method of the present invention further comprises: producing a feature on an exposed surface of the flexible substrate defined by the pattern.

Further embodiments, features, and advantages of the present inventions, as well as the structure and operation of the various embodiments of the present invention, are described in detail below with reference to the accompanying drawings.

### BRIEF DESCRIPTION OF THE DRAWINGS

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIGS. 1A, 1B and 1C provide a schematic representation of a flexible substrate for use with the present invention.

FIGS. 2A, 2B, 2C, 2D and 2E provide schematic cross-sectional representations of a soft lithography process useful for patterning a flexible substrate.

FIGS. 3A, 3B, 3C, 3D and 3E provide schematic cross-sectional representations of a soft lithography process useful for patterning a flexible substrate.

FIGS. 4A, 4B, 4C, 4D and 4E provide schematic cross-sectional representations of a soft lithography process useful for patterning a flexible substrate.

FIGS. 5A, 5B, 5C, 5D and 5E provide schematic cross-sectional representations of a soft lithography process useful for patterning a flexible substrate.

FIG. 6 provides a schematic cross-sectional representation of a portion of an apparatus comprising a single rigid or semi-rigid member suitable for patterning a flexible substrate using a soft lithography process.

FIG. 7 provides a schematic three-dimensional cross-sectional representation of a portion of an apparatus comprising two rigid or semi-rigid members suitable for patterning a flexible substrate using a soft lithography process.

FIGS. 8A, 8B and 8C provide schematic cross-sectional representations of an apparatus and process for patterning a flexible substrate using soft lithography.

FIGS. 8D, 8E and 8F provide schematic cross-sectional representations of an apparatus and process for patterning a flexible substrate using soft lithography.

FIGS. 8G, 8H and 8I provide schematic cross-sectional representations of an apparatus and process for patterning a flexible substrate using soft lithography.

FIG. 9 provides a schematic cross-sectional representation of a multi-sided stamp suitable for use with the apparatus and process of the present invention.

FIG. 10 provides a schematic cross-sectional representation of an apparatus suitable for patterning a flexible substrate using a soft lithography process, followed by a wet etching process.

One or more embodiments of the present invention will now be described with reference to the accompanying drawings. In the drawings, like reference numbers can indicate identical or functionally similar elements. Additionally, the left-most digit(s) of a reference number can identify the drawing in which the reference number first appears.

### DETAILED DESCRIPTION OF THE INVENTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described call include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

The present invention is directed to methods for patterning a flexible substrate. As used herein, “flexible” refers to a material capable of being flexed, or undergoing elastic deformation in response to applied external force. In some embodiments, the flexible substrate is capable of being rolled upon itself. Flexible substrates suitable for use with the present invention are not particularly limited by size, composition or geometry. For example, the present invention is suitable for patterning substrates that can be homogeneous or heterogeneous in composition (e.g., a laminate). The present invention is also not limited by surface roughness or surface waviness, and is equally applicable to smooth, rough and wavy surfaces, and surfaces exhibiting heterogeneous surface morphology (i.e., surfaces having a varying composition and/or varying degrees of smoothness, roughness and/or waviness). In some embodiments, the flexible substrate is capable of wrapping around a the circumference of a cylinder having a diameter of about 50 cm or less, about 30 cm or less, about 20 cm or less, about 10 cm or less, about 5 cm or less, about 2 cm or less, or about 1 cm or less without distorting (i.e., undergoing plastic deformation), cracking, or breaking.

Flexible substrates suitable for use with the present invention include, but are not limited to, plastic substrates, metallic and/or ceramic foils, coated substrates, laminates, textiles, composite substrates, thin film substrates, and any other flexible materials that can be processed in the form of sheets. Flexible substrates suitable for use with the present invention include continuous sheets, perforated sheets, porous materials, materials having holes there through, and the like.

Plastics suitable for use as flexible substrates with the present invention include those materials disclosed, for example but not limitation, in Plastics Materials and Processes: A Concise Encyclopedia, Harper, C. A. and Petrie, E. M., John Wiley and Sons, Hoboken, N.J. (2003) and Plastics for Engineers: Materials, Properties, Applications, Domininghaus, H., Oxford University Press, USA (1993), which are both incorporated herein by reference in their entirety.

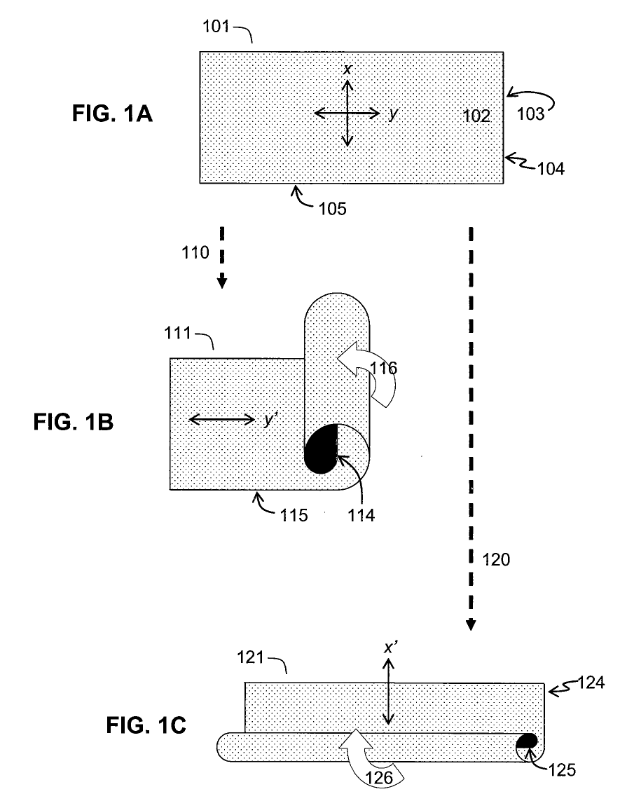

FIGS. 1A, 1B and 1C provide a schematic representation of a flexible substrate suitable for use with the present invention. Referring to FIG. 1A, the flexible substrate, 101, having a front side, 102, and a backside, 103, is viewed laying flat, parallel to an x, y plane such that a first edge, 104, is perpendicular to the y-axis, y, and a second edge, 105, is perpendicular to a x-axis, x. In some embodiments, the flexible substrate is capable of being rolled upon itself, 110 or 120.

Referring to FIG. 1B, a force, 116, is applied to the first edge of the flexible substrate, 114, such that the flexible substrate, 111, rolls upon itself along the y-axis, y. The second edge of the substrate, 115, can remain stationary during rolling and/or flexing of the substrate along the y-axis, y. In some embodiments, it is possible to flex and/or roll the substrate along the x-axis, x. Referring to FIG. 1C, a force, 126, is applied to the second edge of the flexible substrate, 125, such that the flexible substrate, 121, rolls upon itself along the x-axis, x. The second edge of the substrate, 124, can remain stationary during rolling and/or flexing of the substrate along the x-axis, x. While FIGS. 1B and 1C depict a substrate capable of flexing in either of two directions, it is also within the scope of the present invention that flexible substrate can be rolled upon itself or otherwise flexed along a skewed axis (i.e., an axis not aligned perpendicular or parallel to an edge of the substrate). It is also within the scope of the present invention that a flexible substrate be asymmetrically flexible, such that the flexible substrate cannot be flexed along a first axis, but can be flexed and/or rolled upon itself along a second axis.

### The Patterning Process

The patterning processes for use with the present invention are soft lithography processes. As used herein, “soft lithography” refers to a patterning process in which a “stamp” having a topographical pattern and a flexible or elastomeric morphology is placed in conformal contact with a surface, and the topographical pattern in the stamp is transferred to the surface by imprinting or molding a viscous reagent present on the surface, or transferring an “ink” from the topographical pattern in the surface of the stamp to the surface of the flexible substrate. As used herein, “soft lithography” includes micro-contact printing (“μCP”), replica molding, micro-molding in capillaries (“MIMIC”), micro-transfer molding (“μTM”), solvent-assisted micro-contact molding (“SAMIM”), near-field optical lithography, near-field phase-shifting optical lithography, and combinations thereof, and any other patterning processes utilizing a stamp that are known to persons of ordinary skill in the art of patterning substrates.

The soft lithography processes for use with the present invention employ a “stamp.” Stamps for use with the present invention comprise a flexible material having a surface that includes a topographical pattern therein. Flexible materials for use as stamps can undergo elastic deformation and compression in response to an external force. Not being bound by any particular theory, the flexibility of a stamp can ensure that conformal contact is achieved between a patterned surface of a stamp and a surface of a flexible substrate. In some embodiments, a stamp for use with the present invention has a Young's modulus of about 1 MPa to about 2,000 MPa. In some embodiments, a stamp for use with the present invention has a maximum Young's modulus of about 2,000 MPa, about 1,500 MPa, about 1,200 MPa, about 1,000 MPa, about 800 MPa, about 600 MPa, about 400 MPa, about 200 MPa, about 100 MPa, about 80 MPa, about 60 MPa, about 40 MPa, or about 20 MPa. In some embodiments, a stamp for use with the present invention has a minimum Young's modulus of about 1 MPa, about 2 MPa, about 3 MPa, about 5 MPa, about 7 MPa, about 10 MPa, about 15 MPa, or about 20 MPa. In some embodiments, the Young's modulus of the stamp can be varied to optimize the patterning process. For example, as the lateral dimensions of a desired pattern decrease, the Young's Modulus of a stamp can increase to ensure that the lateral dimensions of the stamp are transferred to the patterned substrate without distortion. In some embodiments, a stamp can be selected or manufactured based on its Young's modulus, which in addition to depending on the chemical composition of the stamp can also be controlled by process conditions used to prepare the stamp such as modifying a prepolymer composition, selection of a curing agent, a curing time, a curing temperature, and combinations thereof.

Flexible materials suitable for use with stamps of the present invention include, but are not limited to, a poly(dimethylsiloxane), a poly(silsesquioxane), a poly(isoprene), a poly(butadiene), a styrene-butadiene copolymer, a polychloroprene, a natural rubber, a butyl rubber, a halogenated butyl rubber, a nitrile rubber, a hydrated nitrile rubber, an ethylene-propylene rubber, an epichlorohydrin rubber, a polyacrylic rubber, a silicone rubber, a fluorosilicone rubber, a tetrafluoro ethylene/propylene rubber, a fluoroelastomer, a perfluoroelastomer, teflon, a chlorosulfonated polyethylene, an ethylene vinyl acetate, a polyurethane, a polyimide, a phenol-formaldehyde polymer, and combinations thereof. Other materials suitable for use in stamps, and methods to prepare stamps suitable for use with the present invention are disclosed in U.S. Pat. Nos. 5,512,131; 5,900,160; 6,180,239; and 6,776,094; and pending U.S. application Ser. No. 10/766,427, all of which are incorporated herein by reference in their entirety.

A stamp for use with the present invention comprises a surface having at least one indentation therein, the indentation being contiguous with and defining a pattern in the surface of the stamp. A stamp having a topographical pattern and a flexible or elastomeric morphology can be prepared from a master comprising a topographical pattern in the surface of a rigid or semi-rigid material, composite, and the like (e.g., a silicon wafer having a patterned photoresist layer thereon).

The stamp is adapted to remain stationary during at least a portion of the patterning process. Not being bound by any particular theory, a stationary stamp during the patterning process can facilitate transfer of a pattern from the stamp to the flexible substrate in a reproducible manner. First, having a stationary stamp during the patterning minimizes distortions in the surface of the stamp. In addition to enabling a reproducible patterning process, a stationary stamp will also wear or degrade less readily. Moreover, this process takes advantage of the flexible properties of the substrate during both contacting the stamp and removing the patterned flexible substrate from the stamp surface. Maintaining the structural shape of the stamp during contacting and pattern transfer permits a wide variety of materials to be patterned with the same basic equipment design.

As used herein, a “pattern” refers to a feature formed on a flexible substrate. As used herein, a pattern includes both positive and/or negative images formed on a surface of a feature or features in the surface of a stamp. In some embodiments, the pattern formed on a flexible substrate comprises a monolayer. In some embodiments, the pattern formed on a flexible substrate comprises a thin film. In some embodiments, the pattern formed on a flexible substrate comprises a fluidic composition that is cured, reacted, treated, and the like to form a solid on the surface of the flexible material in substantially the same pattern. Alternatively, a fluidic composition can react with at least a portion of the surface of the flexible material to produce a relief pattern thereon.

A pattern can comprise an “ink” such as, but not limited to, a fluid, a paste, a gel, a cream, a colloid, a dispersion, a solution, a particulate, or any other composition capable of being applied to a surface of a flexible material, a surface of a stamp, an indentation in a surface of a stamp, and combinations thereof. In some embodiments, an ink is applied uniformly to a flexible substrate and/or a surface of a stamp. In some embodiments, an ink comprises an etchant, a nanoparticle, a metal, a metal oxide, a polymer, a polymer precursor, and combinations thereof.

In some embodiments, a pattern can be defined by its physical dimensions. All patterns have at least one lateral dimension. As used herein, a “lateral dimension” refers to a dimension of a pattern that lies in the plane of a flexible substrate. One or more lateral dimensions of a pattern define, or can be used to define, the area of a substrate that a pattern occupies. Typical lateral dimensions of patterns include, but are not limited to: length, width, radius, diameter, and combinations thereof. In some embodiments, a pattern formed on a flexible substrate by an apparatus or method of the present invention has at least one lateral dimension of about 10 mm or less, about 1 mm or less, about 100 μm or less, about 10 μm or less, about 1 μm or less, about 500 nm or less, about 100 nm or less, or about 50 nm or less. In some embodiments, a pattern formed on a flexible substrate by an apparatus or method of the present invention has a minimum lateral dimension of about 100 nm, about 200 nm, about 500 nm, about 1 μm, or about 5 μm.

Patterns formed on a flexible substrate by the process or apparatus of the present invention include, but are not limited to, structural patterns, etched patterns, conductive patterns, semi-conductive patterns, insulating patterns, and masking patterns.

A “structural pattern” refers to a pattern having a composition similar or identical to the composition of the surface on which the pattern is produced.

An “etched pattern” refers to a pattern that is formed by removing a portion of the flexible substrate using, for example, an etchant capable of reacting with a portion of the flexible substrate. An etchant can be present in an ink or can be applied to a portion of the flexible substrate not covered by a masking pattern.

A “masking pattern” refers to a pattern that has composition that is inert to reaction with a reagent that is reactive towards the surface areas adjacent to and surrounding the pattern. Thus, a pattern can be used to protect a surface or a selected area of a surface during subsequent processes, such as, but not limited to, etching, deposition, implantation, and surface treatment processes. In some embodiments, a masking pattern is removed during or after subsequent processes.

A “conductive pattern” refers to a pattern having a composition that is electrically conductive, or electrically semi-conductive. Electrically semi-conductive patterns include patterns whose electrical conductivity can be modified based upon an external stimulus such as, but not limited to, an electrical field, a magnetic field, a temperature change, a pressure change, exposure to radiation, and combinations thereof.

An “insulating pattern” refers to a pattern having a composition that is electrically insulating.

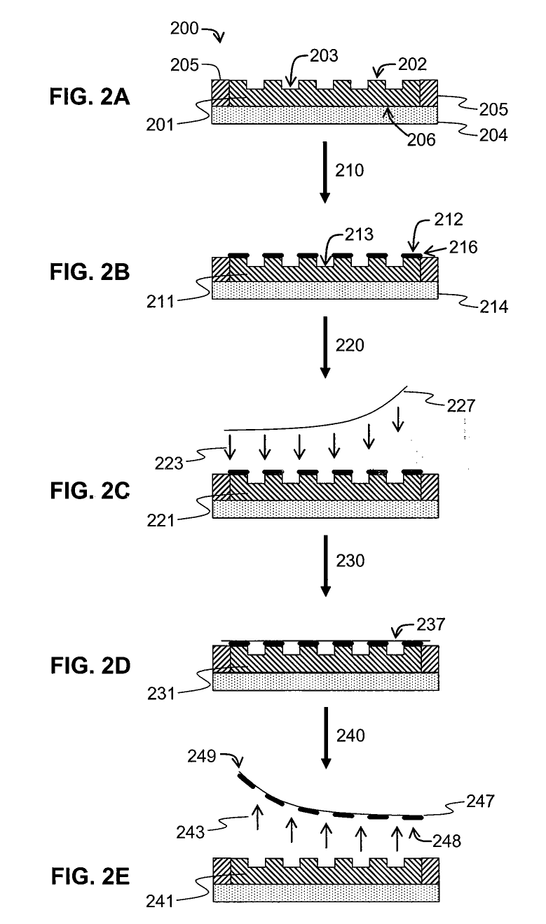

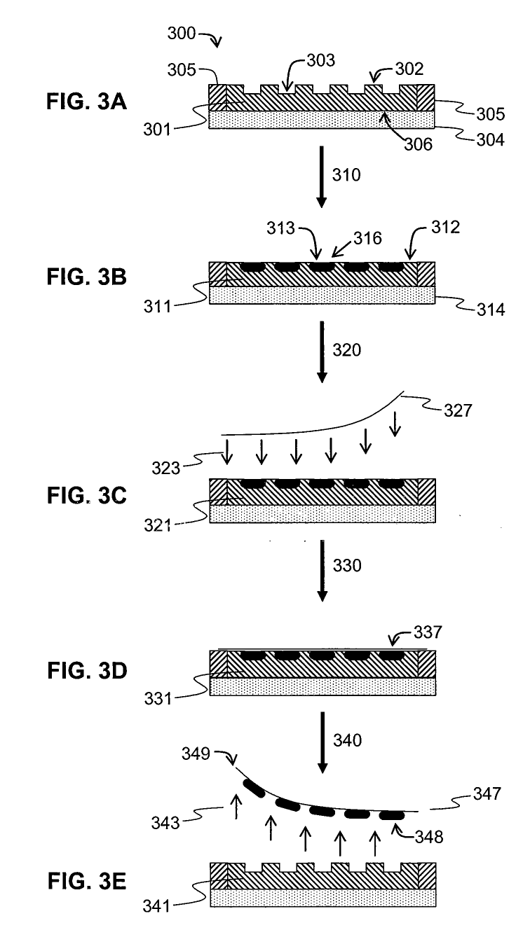

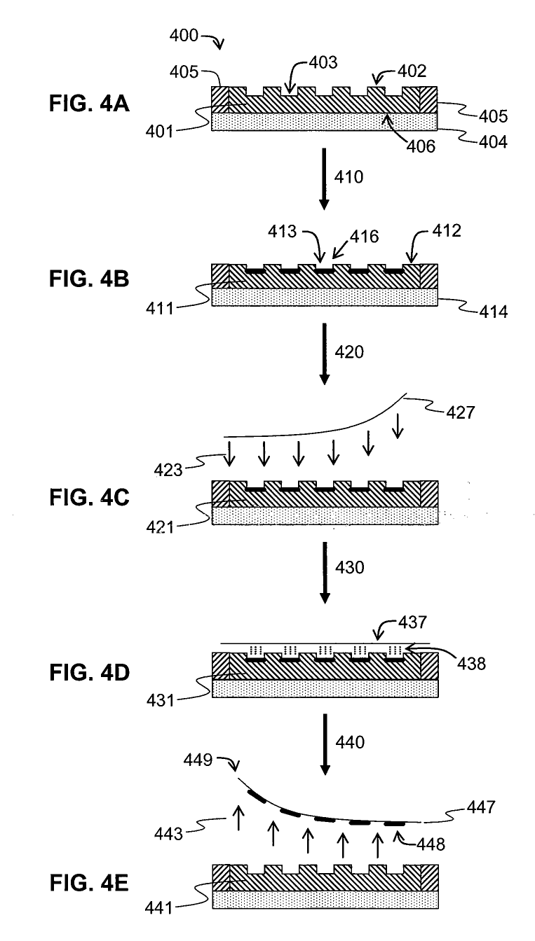

Flexible substrates can be patterned with features using a variety of methods for transferring the features from a stamp to the flexible substrate. The processes depicted in FIGS. 2A-2E, FIGS. 3A-3E and FIGS. 4A-4E display schematic cross-sectional representations of processes suitable for transferring a pattern from a stamp to a flexible substrate. FIGS. 2A-2E display a schematic cross-sectional representation of a process for transferring a pattern from the upraised portions of a stamp to the surface of a flexible substrate. Conversely, FIGS. 3A-3E and FIGS. 4A-4E display schematic cross-sectional representations of processes for transferring patterns from indentations in the surface of a stamp to the surfaces of flexible substrates.

FIGS. 2A, 3A and 4A display schematic cross-sectional representations of stamps, 200, 300 and 400, respectively, comprising a flexible material, 201, 301 and 401, respectively, having a surface, 202, 302 and 402, respectively, with a topographical pattern formed therein comprising at least one indentation, 203, 303 and 403, respectively. In some embodiments, the stamp further comprises a backing layer, 204, 304 and 404, respectively, that can add rigidity to the stamp, be used to apply pressure to the backside of the stamp, make the stamp easier to handle during manufacture and processing, and in some embodiments can comprise a reservoir suitable for containing an ink that can be applied to the stamp surface through a back surface of the stamp, 206, 306 and 406, respectively. In some embodiments, the stamp further comprises one or more rigid or semi-rigid members, 205, 305 and 405, respectively, adjacent to the stamp, 201, 301 and 401, respectively, that can ensure that the dimensions of the stamp surface are maintained during the printing process.

FIGS. 2B, 3B and 4B display schematic cross-sectional representations of stamps, 211, 311 and 411, respectively, after the application, 210, 310, and 410, respectively, of ink, 212, 312 and 412. The applying, 210, 310 and 410, respectively, can be performed using, for example and not by way of limitation, vapor deposition, liquid deposition, roller application, and combinations thereof, and any other ink application methods known to persons of ordinary skill in the printing arts. In some embodiments, the ink is applied in a substantially uniform thickness to the surface of the stamp. For microcontact printing applications, as represented schematically by FIGS. 2A-2E, it is important that the protruding surfaces of the stamp, 202 and 212, as shown in FIGS. 2A and 2B, respectively, be uniformly coated by an ink because it is these surfaces of the stamp that transfer an ink pattern to a flexible substrate.

Referring to FIGS. 2B, 2C and 2D, it is also within the scope of the present invention for an ink to be contained within a backing layer, 214, 314 and 414, respectively, wherein the ink can be applied from the backing layer of the stamp to the stamp surface, 212, 312 and 412, respectively, by a process of, e.g., capillary action, a microfluidic channel, a porous structure formed by the backing layer and the stamp, a pumping device, and combinations thereof. For example, a reservoir formed by or contained within the backing layer of a stamp can be filled with a volume of ink suitable for printing multiple patterns on a single substrate or multiple substrates. By maintaining fluid communication between the reservoir and a surface of the stamp having a pattern therein the need to manually re-ink the stamp surface between printing operations is minimized, thereby permitting continuous patterning processes.

Referring to FIG. 2B displays a schematic cross-sectional representation of an ink, 216, applied to the raised portions, 212, of a stamp, 211, and in which the indentations, 213, in the surface of the stamp are free from ink. FIG. 3B displays a schematic cross-sectional representation of an ink, 314, deposited into the indentations, 313, of a stamp, 311, and in which the raised portions, 312, of the stamp (i.e., the face of the stamp) are free from ink. In FIG. 3B the level of ink filling the indentations of the stamp is approximately even with the height of the face of the stamp. FIG. 4B displays a schematic cross-sectional representation of an ink, 414, deposited into the indentations, 413, of a stamp, 411, and in which the raised portions, 412, of the stamp (i.e., the face of the stamp) are free from ink. In FIG. 4B the level of ink filling the indentations of the stamp is below the height of the face of the stamp.

FIGS. 2C, 3C and 4C display schematic cross-sectional representations of a flexible substrate, 227, 327 and 427, respectively, contacting, 223, 323 and 423, respectively, an inked surface of a stamp, 221, 321 and 421, respectively. The stamp is immobile during the contacting, printing, and removal (the process(es) depicted in FIGS. 2C-2E, FIGS. 3C-3E and FIGS. 4C-4E, respectively). In particular, it is important that the flexible substrate is contracted with the surface of the stamp in a “rolled” manner in which one edge of the flexible substrate first contacts a first edge of the stamp, and the remaining surface of the flexible substrate is then applied across the surface of the stamp using the first contact edge as an anchoring point. This application process permits uniform, conformal contact between the substrate and stamp, and takes advantage of the flexible properties of the substrate to exclude gases from the stamp-substrate interface during application. While it is a requirement that the entire surface of the flexible substrate that is to be patterned contact the stamp at some point during the printing process, it is not crucial that the entire surface of the flexible substrate contact the stamp surface at the same time. For example, the first anchor point can traverse the surface of the stamp to remove a portion of the flexible substrate prior to the entire flexible substrate being applied to the stamp.

Complete application of the substrate to the stamp, 230, 330 and 430, results in conformal contact of the substrate with the entire face of the stamp, as depicted in FIGS. 2D, 3D and 4D, respectively.

Upon contacting the flexible substrate with the surface of the stamp, an ink is transferred from the stamp to the substrate. FIGS. 2D, 3D and 4D display schematic cross-sectional representations of the transfer of ink from a stamp, 231, 331 and 431, respectively, to a flexible substrate, 237, 337 and 437, respectively. In some embodiments, the ink is transferred to the substrate via direct contact, as depicted in FIGS. 2D and 3D. In some embodiments, mechanical pressure can be applied to one or both of the back side of the flexible substrate and the stamp during application, 223, 323 and 423, respectively. Alternatively, another force such as, but not limited to, a magnetic force, an electrostatic force, a fluid tension force, a vacuum applied to a volume enclosed by the surfaces of the stamp and the flexible substrate, and the like, can promote conformal contact between the flexible substrate and the stamp during the contacting.

Referring to FIG. 4D, in some embodiments an ink is transferred from a stamp to a substrate via a vapor phase chemical reaction, or another non-contact interaction or reaction, 438, such as, but not limited to, a magnetic interaction, an electrostatic interaction, and the like, wherein simultaneous contact among the ink, the stamp, and the flexible substrate is not required.

After the substrate is contacted with the stamp for an amount of time sufficient to transfer the ink from the stamp to the substrate, the substrate is removed from the stamp, 240, 340 and 440, respectively.

FIGS. 2E, 3E and 4E display schematic cross-sectional representations of process of removing a flexible substrate, 247, 347 and 447, respectively, from a stamp, 241, 341 and 441, respectively. The removal of a flexible substrate from a stamp can comprise the reverse of the application process: beginning at one edge of the stamp, the substrate is peeled away from the stamp until the entire substrate is detached the face of the stamp. The peeling process is promoted by applying a removing force, 243, 343 and 443, respectively, to the flexible substrate that can be applied for example, by a collector reel, a spooling reel or element, an adhesive interaction between the backside of the flexible substrate and the surface of the rigid or semi-rigid member (resulting in, e.g., a frictional force between these elements), and the like, and combinations thereof. The removing force, 243, 343 and 443, respectively, can also be applied to diminish an adhesive interaction between the stamp and the flexible substrate such as, but not limited to, blowing a gas and/or vapor on the substrate/stamp interface, flowing a liquid between the surfaces of the stamp and flexible substrate, reducing a vacuum applied to a volume enclosed by the surfaces of the stamp and the flexible substrate, and the like.

FIGS. 2E, 3E and 4E depict a leading edge, 249, 349 and 449, respectively, being removed first from the surface of the stamp, it is within the scope of the present invention that the removing can be initiated at any edge of the flexible substrate.

Not being bound by any particular theory, by removing the flexible substrate from the stamp by a peeling process (i.e., by initiating the removing at an edge of the stamp), the spatial resolution of the printed features on the flexible substrate is retained because deformation of the printing surface of the stamp is minimized. Additionally, deformation forces applied to the flexible substrate are constant across the surface of the flexible substrate, and the flexible substrate is not flexed to any degree greater than that which would be expected during its normal use (i.e., plastic deformation of the flexible substrate does not typically occur during the patterning process).

Referring to FIG. 2E, the printed features, 248, on the flexible substrate, 247, are transferred from the stamp, 141, to surface areas of the substrate that contact the stamp face. Referring to FIGS. 3E and 4E, the printed features, 348 and 448, respectively, on the substrate, 347 and 447, respectively, are transferred from the stamp, 341 and 441, respectively, to surface areas of the substrate that contact indentations in the stamp face.

Flexible substrates can be patterned with features using a variety of methods for transferring the features from a stamp to the flexible substrate. The processes depicted in FIGS. 2A-2E, FIGS. 3A-3E and FIGS. 4A-4E display schematic cross-sectional representations of processes suitable for transferring a pattern from a stamp to a flexible substrate. FIGS. 2A-2E display a schematic cross-sectional representation of a process for transferring a pattern from the upraised portions of a stamp to the surface of a flexible substrate. Conversely, FIGS. 3A-3E and FIGS. 4A-4E display schematic cross-sectional representations of processes for transferring patterns from indentations in the surface of a stamp to the surface of a flexible substrate.

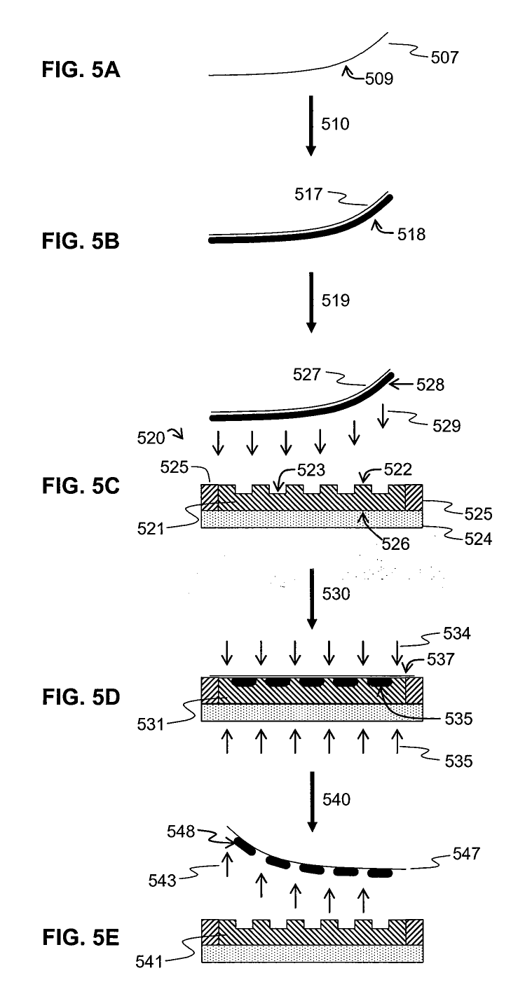

In some embodiments, a fluidic ink deposited on a flexible substrate can be molded to form a pattern on the flexible substrate by applying a stamp to the fluidic ink. This process creates an ink pattern on the flexible substrate having lateral dimensions defined by an indentation in the surface of the stamp. FIGS. 5A-5E display a schematic cross-sectional representation of a process for patterning a flexible substrate using such a method of the present invention. Referring to FIG. 5A, a flexible substrate, 517, is provided, onto which an ink is then deposited, 510.

Referring to FIG. 5B, an ink, 518, has been deposited to uniformly cover the flexible substrate, 517. Applicable ink deposition methods include those generally known for applying uniform coatings on substrates, such as, but are not limited to, spray coating, dip coating, powder coating, vapor depositing, aerosol depositing, plasma depositing, and the like, and any other deposition methods known to persons of ordinary skill in the deposition arts. While the ink is typically a fluid or fluid containing composition, powders, suspensions, emulsions, particulates, and the like can also be patterned by this method so long as an interaction between the ink and the stamp is sufficient to produce a pattern in the coated flexible substrate. The flexible substrate can be pre-treated prior to ink deposition to produce a contact layer, apply an adhesion promoter, create a functionalized surface, create a hydrophilic surface, and the like, to promote uniform deposition of an ink on the substrate and/or to promote transfer of the pattern from the stamp to the ink and substrate. A resulting ink-coated flexible substrate is then contacted with a stamp, 519.

Referring to FIG. 5C, a stamp, 520, comprising a flexible material, 521, having a surface, 522, with a topographical pattern formed therein comprising at least one indentation, 523, is provided. In some embodiments, the stamp further comprises a backing layer, 524, that can add rigidity to the stamp, be used to apply pressure to the backside of the stamp, make the stamp easier to handle during manufacture and processing, and in some embodiments can comprise a reservoir suitable for containing an ink that can be applied to the stamp surface through a back surface of the stamp, 526. In some embodiments, the stamp further comprises one or more rigid or semi-rigid members, 525, adjacent to the stamp, 521, that can ensure that the dimensions of the stamp surface are maintained during the printing process. An inked surface, 828, of the flexible substrate, 527, is contacted, 526, with the surface, 522, of the stamp, 521. The stamp is immobile during the contacting, printing, and removal processes. In particular, it is important that the flexible substrate, 527, contract the surface, 522, of the stamp, 521, in a “rolled” manner in which one edge of the flexible substrate is contacted with a first edge of the stamp, and the substrate is applied across the surface of the stamp using the first contact edge as an anchor.

Not being bound by any particular theory, the method of applying the flexible substrate to the stamp surface permits the angle of contact between the substrate and the stamp to be held constant across the surface of the stamp. Application of the flexible substrate to the stamp at a constant angle is important for consistent printing of patterns on the flexible substrate. Additionally, the application of the substrate in a rolled manner permits uniform, conformal contact between the substrate and stamp, and takes advantage of the flexible properties of the substrate to exclude gases from the stamp-substrate interface during application.

The flexible substrate is then contacted with the stamp for an amount of time sufficient to transfer the pattern in the stamp to the ink on the surface of the flexible substrate, 530. Referring to FIG. 5D, the flexible substrate, 537, is contacted with the stamp, 531, such that the ink on the surface of the flexible substrate is confined to the pattern in the surface of the stamp, 538. During the contacting, a mechanical pressure or some other force such as, but not limited to, a magnetic force, an electrostatic force, a fluid tension force, a vacuum applied to a volume enclosed by the surfaces of the stamp and the flexible substrate, and the like, can be applied to one or both of the backside of the flexible substrate, 534, the backside of the stamp, 535, a volume enclosed by the surfaces of the stamp and substrate, and combinations thereof. In some embodiments, the surface of the flexible substrate is in conformal contact with a surface of the stamp during the contacting. For example, it is not necessary that the entire surface of the flexible substrate be in conformal contact with the stamp at any one time. It can be sufficient that only a portion of the surface of the flexible substrate contact the stamp at any given time. Specifically, in some embodiments only the area of the flexible substrate that is opposite to the position of a rigid or semi-rigid member will conformally contact the stamp at any moment during the patterning process. The flexible substrate is then removed from the stamp, 540.

Referring to FIG. 5E, the flexible substrate, 547, is removed from the stamp, 541. The removal of a flexible substrate from a stamp can be the reverse of the application process: for example, beginning at one edge of the stamp, the substrate can be peeled away from the stamp until the entire substrate is detached the face of the stamp. Not being bound by any particular theory, by removing the flexible substrate from the stamp using a peeling process, the spatial resolution of the printed features on the substrate is retained, and the stamp does not undergo deformation. In some embodiments, a removing force, 543, as discussed above, can be applied to promote efficient and reproducible removal of the flexible substrate from the stamp. Referring to FIG. 5E, the printed features, 548, on the substrate, 547, are a result of the pattern in the surface of the stamp being transferred from the stamp, 541, to the ink on the flexible substrate.

In particular, the present invention is directed to patterning flexible substrates in a “reel-to-reel” manner. In a reel-to-reel process the material to be patterned is flexible, and is fed from a cylindrical “supply reel” into an apparatus. Circular rollers position and transport the material through the apparatus, and the patterned flexible material is then collected onto a cylindrical “collector reel.” Reel-to-reel processes are particularly desirable because they permit flexible materials to be quickly loaded, processed, and easily transported after processing. Reel-to-reel processes also enable flexible substrates to be patterned in a continuous manner, in which a flexible substrate having a length of tens, hundreds, or thousands of meters in lengths can be patterned.

Moreover, the reel-to-reel process of the present invention permits facile alignment of a flexible substrate with a printing surface (i.e., a surface of a stamp). In some embodiments, the apparatus of the present invention further comprises an aligning means adapted to align a location on a surface of the flexible substrate with a location on the surface of the stamp including at least one indentation therein. An aligning means suitable for use with the present invention include, but are not limited to, a periscope system, a double periscope system, a microscope system, a camera system, a mechanical alignment stage system, a mechanical registration system, an optical registration system, and combinations thereof, and equivalents thereof.

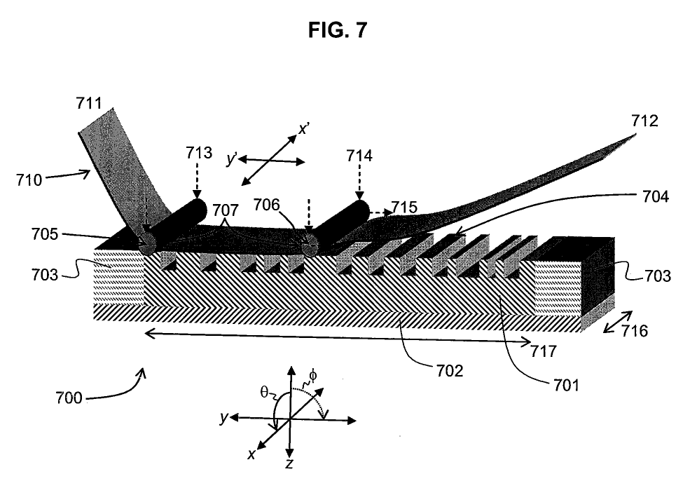

An example of an aligning means includes a double periscope system placed between the stamp and flexible substrate that can view both substrate simultaneously. In some embodiments, such a system can include a closed feedback loop with one or both of the supply reel and the collector reel to ensure the rate at which the flexible substrate is applied to the stamp surface results in pattern overlap and/or a mechanical stage controlling the position of the stamp within a plane parallel to the surface of the flexible substrate. For example, referring to FIG. 7, the stamp position on the x-axis and y-axis and/or an angle of rotation of the flexible stamp, θ, and the angle of inclination of the flexible stamp, φ. A double periscope system is particularly useful when both the stamp and the flexible substrate are opaque because a double periscope system permits an operator, or a computer or robot fitted with an optical input device to observe the position of both the stamp and the flexible substrate simultaneously, and move either or both of the stamp or the flexible substrate until images observed by the double periscope system are aligned. After proper alignment is achieved, the double periscope can be moved from a position between the surface of the stamp and the flexible substrate, and the patterning process can proceed.

A further example of an aligning means includes an optical aligning system such as, but not limited to, a camera system, a periscope system, and/or a microscope system that can view the flexible substrate and the stamp simultaneously, either from a “top”, “bottom”, “side”, or “angle” view to ensure proper registration. In some embodiments, an optical aligning means can be located on the surface of the stamp, or within an indentation in the surface of the stamp. An optical aligning means on the surface of the stamp permits aligning of an opaque stamp with an opaque flexible substrate without using a double periscope system. A further example of an aligning means includes a mechanical aligning system such as, but not limited to, a mechanical aligning stage system (i.e., referring to FIG. 7, a mechanical aligning means adapted to modify or shift any of: the stamp position on the x-axis and y-axis and/or an angle of rotation of the flexible stamp, as indicated by θ, and an angle of inclination of the flexible stamp, as indicated by φ). An aligning means also includes an “open loop” aligning system such as a perforated system on the flexible stamp and/or substrate, a key/hole system between the flexible substrate and the stamp, a marking system on the flexible substrate and/or stamp, a system to control the rate of supply of the flexible substrate, a system to control the rate of collection of the flexible substrate, and the like, and combinations thereof, and equivalents thereof.

Not being bound by any particular theory, an aligning means adapted to align a location on a surface of the flexible substrate with a location on the surface of the stamp including at least one indentation therein is important for accurate alignment of a flexible substrate already having a pattern thereon with a pattern in the surface of a stamp such that there is pattern overlap. One advantage of the present invention is that because multiple patterning operations are made across the length of a flexible substrate, the flexible substrate can be self-aligned in the direction the flexible substrate is supplied and collected. Therefore, alignment is a matter of controlling the supply and/or collection rate. In common practice, an optical aligning means (e.g., a camera system, a periscope system, a double periscope system, a microscope system, and the like) and/or a mechanical aligning means (e.g., a mechanical stage system, a mechanical register system, a key/hole system, and the like) are automatically controlled by at least one of an image capturing and processing software or a mechanical sensor system such that the aligning speed is a function of (i.e., limited by) computer processing speed only. The system of the present invention permits even more rapid aligning speeds because accurate control of supply reel and/or collector reel can be used to achieve fairly accurate “pre-alignment”on the order of tens of microns, to even the micron scale. Thus, the patterning of flexible substrates in which the patterns have a lateral dimension of about several microns or greater can occur much more rapidly than with an experimental or traditional soft lithography apparatus.

In some embodiments, the apparatus of the present invention further comprises an inking means adapted to apply an ink to at least one of: the surface of the stamp including at least one indentation therein, the frontside of the flexible substrate, and combinations thereof. An inking means for use with the present invention can include, but is not limited to, an ink spraying system, an ink pad system, an ink powder coating system, an aerosol system, a chemical vapor depositing system, a spreading system, a wiping system, a brushing system, an extruding system, a spin-coating system, a dip-coating system, a capillary system, a ink-flowing system, a ink reservoir system, and combinations thereof, and equivalents thereof. In some embodiments, an inking means for use with the present invention is adapted to apply an ink layer of substantially uniform thickness to at least one of: a surface of the flexible substrate, a surface of the stamp having at least one indentation therein, an indentation in the surface of the stamp, and combinations thereof. As used herein a substantially uniform thickness refers to a thickness that varies by about 20% or less, about 15% or less, about 10% or less, about 5or less, or about 3% or less across the area to which the ink is applied.

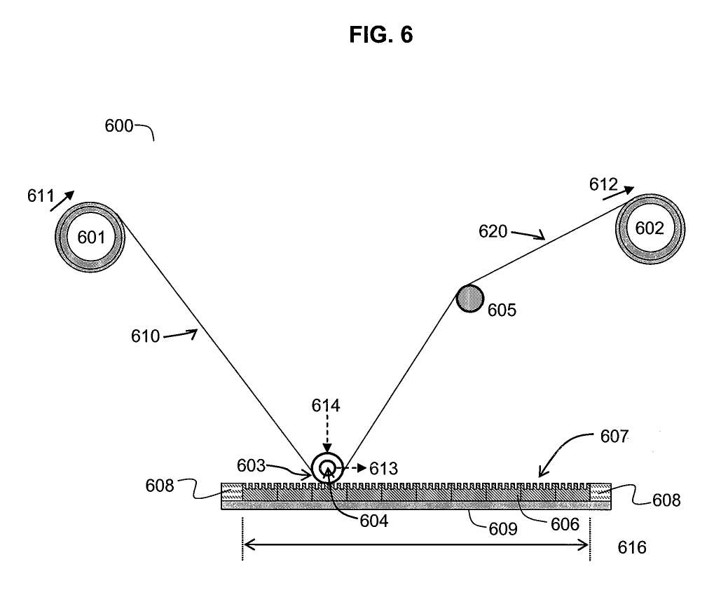

The present invention provides a reel-to-reel apparatus that provides for linear propagation of substrate application to and removal from the stamp surface. FIG. 6 provides a schematic cross-sectional representation of a stamp and a flexible substrate during a patterning process conducted using a single rigid or semi-rigid member. Referring to FIG. 6, the patterning apparatus, 600, comprises a supply reel, 601, a collector reel, 602, a rigid or semi-rigid member, 603, a tension sensor, 604, and a stamp, 605.

Not being bound by any particular theory, the tension sensor, 604, can be used to reproducibly align the flexible substrate with the stamp. Specifically, in some embodiments there will exist an upward or downward “bow” or curve in the portion of the flexible substrate held between a supply reel and a collector reel. Typically, a “wedge correction” is used to compensate for the curvature or bow in a flexible substrate. However, the alignment accuracy will depend on the ability to maintain a constant run-to-run bow in the flexible substrate. The tension controller, 604, can measure the degree of bow or curvature in the flexible substrate and ensures proper alignment of the flexible substrate by maintaining a constant run-to-run bow or curvature in the flexible substrate.

The stamp, 605, can comprise an single or multiple patterned elastomers, 606, that include a surface having at least one indentation therein, 607. The stamp, 605, can also optionally include a support layer, 608, and a backing layer, 609, that can act as a support and/or an ink reservoir. By way of example only and not limitation, FIG. 6 depicts an application process whereby a flexible substrate, 610, is applied to a surface of the stamp, 607, by the action of a single rigid or semi-rigid member, 603. In alternative embodiments, two, three, four, or more rigid or semi-rigid members can be used to apply a flexible substrate to the face of the stamp. In some embodiments, the rigid or semi-rigid members, 603, comprise an optional padded layer that surrounds a rigid core. Pressure, 614, is applied to the rigid or semi-rigid member, 603, such that the flexible substrate, 610, contacts an edge of the stamp. The rigid or semi-rigid member, 603, is then moved across the face of the stamp, 613, while pressure, 614, is continuously applied. The rate at which the flexible substrate, 610, is applied to the face of the stamp, 607, can be controlled by at least one of, a first tension, 611, applied to the supply reel, 601, a second tension, 612, applied to the collector reel, 602, and combinations thereof. The amount of tension present in the flexible substrate can be detected by a tension transducer, 604. After contacting the surface of the stamp, 607, the now patterned flexible substrate, 620, is collected by the collector reel, 602.

It is also within the scope of the present invention for a patterning apparatus to comprise two or more rigid or semi-rigid members suitable for controlling the application of a flexible substrate to a patterned stamp and the removal of the flexible substrate therefrom. FIG. 7 provides a schematic three-dimensional cross-sectional representation of a stamp and a flexible substrate during the process of applying the substrate to the stamp. The stamp assembly, 700, is comprised of a stamp, 701, provided on an optional rigid backing layer, 702, and optional support member, 703. The optional rigid backing layer, 702, and optional support member, 703, can prevent deformation of the stamp during application of the substrate. Materials suitable for use as the optional rigid backing layer and/or the support member include, but are not limited to, glasses, metals, composites, plastics, rubbers, and combinations thereof. In some embodiments, the support member comprises rubber, or a rubber overlayer. In some embodiments, the backing layer can function as an ink reservoir suitable for supplying an ink to the surface of the stamp having at least one indentation therein. The stamp, 701, has a face having a pattern therein, 704, to which the substrate, 710, is applied. The substrate, 710, has a leading end, 711, that is spooled to a collector reel (not shown), and a trailing end, 712, that is spooled to a supply reel (not shown). During the application process a rigid or semi-rigid member, 705, applies pressure to the backside of the flexible substrate, ensuring that the substrate conformally contacts the stamp. By way of example only and not limitation, FIG. 7 depicts an application process whereby a flexible substrate, 710, is applied to the face of the stamp, 704, by the action of two rigid or semi-rigid members, 705 and 706. In alternative embodiments, one, three, four, or more rigid or semi-rigid members can be used to apply a flexible substrate to the face of the stamp. In some embodiments, the rigid or semi-rigid members, 705 and 706, comprise an optional padded layer, 707, that surrounds a rigid core. Pressure, 713, is applied to a first rigid or semi-rigid member, 705, to fix the leading edge of the flexible substrate to a first side of the stamp. The second rigid or semi-rigid member, 706, is then moved across the face of the stamp, 715, while pressure, 714, is applied.

Referring to FIG. 7, during the contacting the stamp, 701, is rigidly positioned during the patterning process such that the stamp surface does not move in any of the x-, y-, or z-axes, and the angle of rotation, θ, and an angle of inclination, φ, are both held constant during the contacting. However, as discussed above, any one of the stamp position along the x-, y-, and z-axes, the angle of rotation, θ, and the angle of inclination, φ, can be adjusted prior to contacting, for example, to ensure accurate alignment of the stamp, 701, and the flexible substrate, 710. The lateral width of the stamp surface, 716, is selected to be approximately the same dimension as the width of the flexible substrate (i.e., as wide as, slightly wider than, or slightly thinner than the width of the flexible substrate). Because the lateral position of the flexible substrate, x′, does not shift during the contacting between the stamp and the flexible substrate, there is no need to align the lateral position of the flexible substrate, x′, with the lateral position of the surface of the stamp, x, during patterning. The transverse position of the flexible substrate, y′, is controlled by tension applied to a supply reel and a collector reel. Thus, the alignment of the flexible substrate with the transverse position of the surface of the stamp, y, can be performed largely by accounting for the length of the stamp in the transverse direction, 717, and controlling the tension on the supply reel and the collector reel to supply this length of flexible substrate into the patterning area. Importantly, there is only a minimal need to directly align a point on the flexible substrate with an analogous point on the stamp, which greatly simplifies the patterning process. As discussed above, the apparatus of the present invention achieves superior alignment speeds by minimizing the amount a flexible substrate and or stamp must be shifted during an aligning step. The vertical position of the flexible substrate, z′, is controlled by one or more rigid members, 705, and optionally, 706. Because the only alignment operation associated with the process and apparatus of the present invention is controlling the length of flexible substrate supplied to the printing area, the present invention avoids hysteresis that can be associated with alignment robotics, as well as the time-consuming operations associated with aligning a surface and substrate in a 1:1 manner.

Not being bound by any particular theory, control of the substrate tension during all stages of the printing process permits patterning of a flexible substrate in a reproducible manner. Specifically, because a flexible substrate, and not the stamp, is placed under tension and thereby flexed during patterning, there is less print-to-print distortion in the pattern of the stamp due to registration errors, distortions of the pattern, and the like.

Moreover, for soft lithography applications in which an ink must be uniformly applied to a stamp prior to patterning, reducing both the amount and degree to which a stamp is flexed will reduce variability in the degree of ink absorption by the stamp as well as the level of pattern degradation on the surface of the stamp due to, e.g., cracking, deformation, and the like.

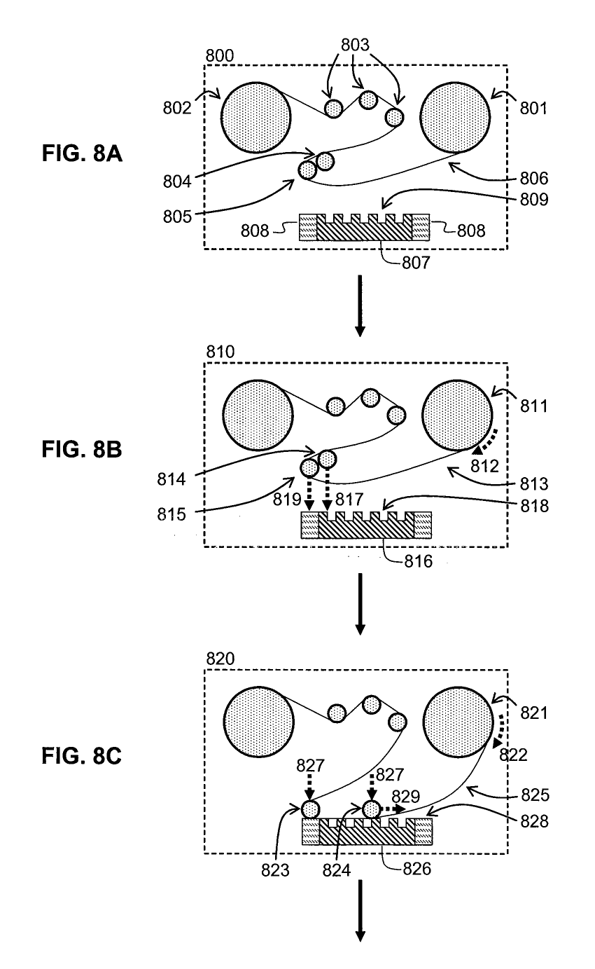

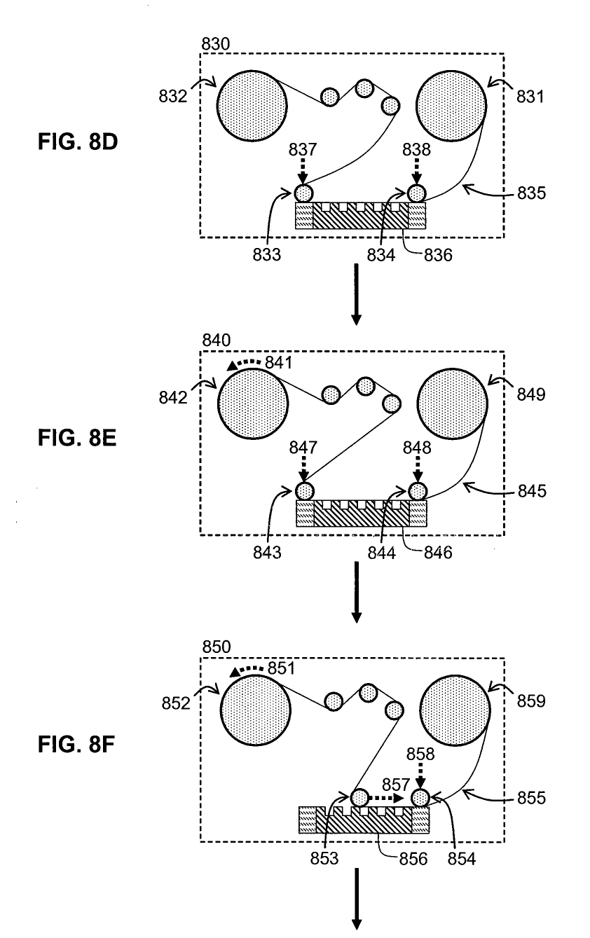

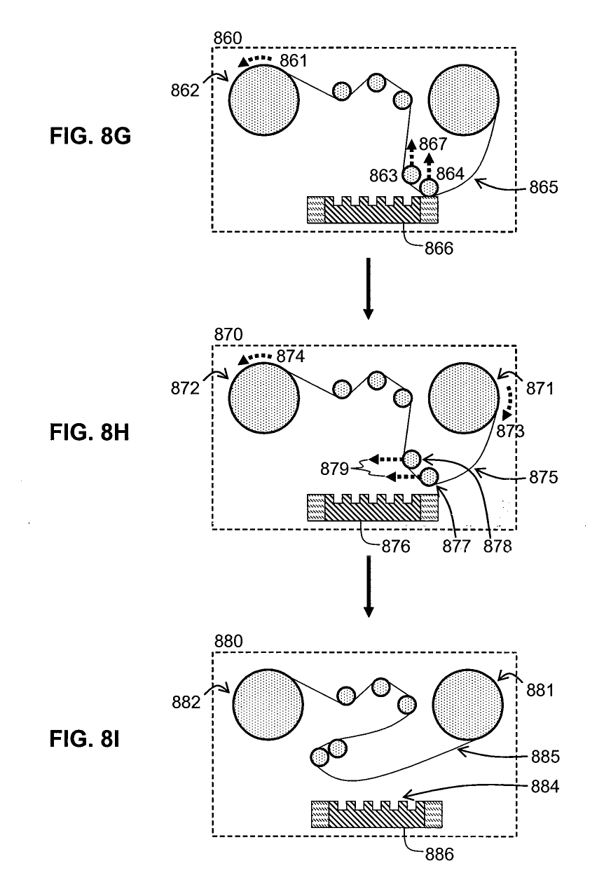

A detailed cross-sectional representation of an apparatus of the present invention and its operation in patterning a flexible substrate is provided in FIG. 8A-8C, FIG. 8D-8F and FIG. 8G-5I. FIG. 8A provides an apparatus, 800, comprising a supply reel, 801, a collector reel, 802, and various transit rollers, 803, which serve to move the flexible substrate, 805, between the supply and collector reels. The transit rollers set the “peel off” angle. As used herein, the “peel off” angle refers to the angle the flexible substrate forms with the surface of the stamp during removal of the flexible substrate from the surface of the stamp. The peel off angle can determine the degree of deformation the flexible substrate undergoes during removal from the stamp. In some embodiments, one of the transit rollers, 803, can be a tension transducer to enable closed loop tension control during the patterning process. In some embodiments, another of the rollers can serve to maintain a consistent angle that the flexible substrate makes with a tension transducer. Also provided are rigid or semi-rigid members, 804 and 805, which position the flexible substrate above the stamp, 806, having optional support members, 807. Prior to patterning, the rigid or semi-rigid members, 804 and 805, can be positioned proximate to an edge of the stamp, or alternatively, proximate to a surface of the stamp. As depicted in FIG. 8A, both the supply and collector reels have neutral tension applied, and the rigid or semi-rigid members are stationary. In this configuration, the stamp could be rotated or moved for cleaning, inking, or pre-treatment, prior to fixing the position of the stamp, and beginning the process of contacting the flexible substrate with the stamp surface.

FIG. 8B provides a cross-sectional representation of an apparatus of the present invention, 810, during the process of contacting a flexible substrate, 813, with a face of a stamp, 816, having a pattern, 818, therein. Negative tension, 812, is applied to the supply reel, 811, to feed flexible substrate from the supply reel. The rigid or semi-rigid members, 814 and 815, are moved towards the stamp, 816, until the rigid or semi-rigid members bring the flexible substrate into contact with the stamp. The collector reel is held in a fixed position during this process. In the embodiment depicted schematically in FIG. 8B the rigid or semi-rigid members induce contact between the stamp and the flexible substrate at an edge of the stamp. In some embodiments, the rigid or semi-rigid members can induce contact between the flexible substrate and the stamp at any position on the face of the stamp, 818, or alternatively, the rigid or semi-rigid members can induce contact between the flexible substrate and an optional support member adjacent to and surrounding the face of the stamp.

FIG. 8C provides a second schematic cross-sectional representation of an apparatus of the present invention, 820, during the process of contacting a flexible substrate with a stamp. After the rigid or semi-rigid members are positioned such that the flexible substrate is in contact with the surface of the stamp, pressure, 827, is applied to one of the rigid or semi-rigid members, 823, to fix its position. Pressure, 827, is also applied to the second rigid or semi-rigid member, 824, as it moves transversely, 829, across the face of the stamp, 828. During this process additional flexible substrate is provided by applying negative tension, 822, to the supply reel, 821. The collector reel is maintained in a fixed position during this process to prevent movement of the flexible substrate.

FIG. 8D provides a schematic cross-sectional representation of an apparatus of the present invention, 830, at the completion of the contacting process. Pressure, 837 and 838, is applied to the rigid or semi-rigid members, 833 and 834, respectively, to maintain the members in a fixed position for a predetermined amount of time. During this segment of the process the flexible substrate, 835, is in conformal contact with the stamp, 836. During this segment of the process both the supply reel, 831, and the collector reel, 832, remain in fixed positions.

The predetermined amount of time for which the flexible substrate contacts the stamp is generally the amount of time required to transfer an ink from the surface of the stamp to the flexible substrate. In some embodiments, the amount of time necessary to transfer an ink from the surface of the stamp to the flexible substrate is about 10 seconds to about 1 hour, about 10 seconds to about 10 minutes, or about 10 seconds to about 1 minute.

FIG. 8E provides a schematic cross-sectional representation of an apparatus of the present invention, 840, at the onset of the process of removing the flexible substrate, 845, from the stamp, 846. As in the previous segment of the patterning process, pressure, 847 and 848, continues to be applied to the rigid or semi-rigid members, 843 and 844. Positive tension, 841, is applied to the collector reel, 842, inducing collection of the flexible substrate around the collector reel. This also provides tension in the flexible substrate between the collector reel and the first rigid or semi-rigid member, 843. The supply reel, 849, is held in a fixed position during this segment of the process.

FIG. 8F provides a schematic cross-sectional representation of an apparatus of the present invention, 850, during the process of removing the flexible substrate, 855, from the stamp, 856. As positive tension, 851, continues to be applied to the collector reel, 852, the first rigid or semi-rigid member, 853, moves across the face of the stamp, 857, towards the second rigid or semi-rigid member, 854, which is held in a fixed position by applying pressure, 858. As the first rigid or semi-rigid member traverses the stamp, the flexible substrate is peeled away from the surface of the stamp. The supply reel, 859, is held in a fixed position during this segment of the process. In some embodiments that employ two rigid or semi-rigid members, both the members can traverse the face of the stamp to meet in the middle of the stamping surface.

FIG. 8G provides a schematic cross-sectional representation of an apparatus of the present invention, 860, after removing a flexible substrate, 865, from the surface of a stamp, 866. At this point in the process positive tension, 861, continues to be applied to the collector reel, 862, and the rigid or semi-rigid members, 863 and 864, are moved away, 867, from the surface of the stamp, 866. The collector reel, 862, collects the flexible substrate during the process of lifting the rigid or semi-rigid members away from the stamp.

FIG. 8H provides a schematic cross-sectional representation of an apparatus of the present invention, 870, during the process of moving the rigid or semi-rigid members, 877 and 878, back to their “original” positions, as depicted in FIG. 8A. During this segment of the process the rigid or semi-rigid members, 877 and 878, traverse, 879, the stamp, 876, while the negative tension, 873, is applied to the supply reel, 871, and positive tension, 874, is applied to the collector reel, 872.

FIG. 8I provides a schematic cross-sectional representation of an apparatus of the present invention, 880, after the patterning of an area of a flexible substrate, 885, has been completed and the apparatus is idle, ready to pattern a second area of the flexible substrate, 885. Neutral tension is applied to both the supply reel, 881, and collector reel, 882, at this time. A freshly inked stamp, 886, replaces the stamp that was used to pattern the flexible substrate in FIG. 8A-8H.

### The Stamp

In addition to the process for controlling, positioning, contacting, and removing the flexible substrate and the stamp, the stamp itself is an integral element of the present invention. True high-throughput processing in a reel-to-reel manner rely on the use of multiple stamping surfaces (i.e., a single stamp comprising multiple surfaces and/or multiple stamps) such that while patterning of a first area of a substrate is performed with a first stamp, a second stamp, or stamping surface is being cleaned, inked, and dried in preparation for patterning of a second area of the substrate. In some embodiments, multiple stamps can be employed using a conveyor, turntable, or the like, capable of positioning a first stamp surface in a fixed position suitable for patterning a substrate, and moving the first stamp surface while simultaneously providing a second stamp surface for patterning a second area of the substrate.

The number of stamp surfaces suitable for use for such an invention can be determined by the time required for cleaning, pre-treating, and inking of the stamps subsequent to a first patterning process, and prior to a second patterning process. Economic considerations such as rate of stamp wear, apparatus footprint, and material cost are also factors that can assist in selecting the optimum number of stamping surfaces to employ with a patterning apparatus of the present invention. In some embodiments, 2 to about 100, 2 to about 50, 2 to about 20, 2 to about 10, 2 to about 5, about 5 to about 20, or about 5 to about 10 stamp surfaces can be used with the apparatus of the present invention.

When multiple stamps and/or stamping surfaces are used with the present invention, the stamps and/or stamping surfaces can comprise the same pattern, or heterogeneous patterns. For example, a flexible substrate can be patterned in a manner such that the same pattern is applied with every stamp, or alternatively, the pattern can be irregular (i.e., no stamps used to pattern the substrate have the same pattern), or semi-regular (i.e., repeat every x stamps, where x is an integer from 2 to 100).

The present invention contemplates the use of any positioning mechanism for moving one stamp having multiple patterned surface or multiple stamps having multiple patterned surfaces, the unifying and common feature of these mechanisms being the ability to stabilize (i.e., rigidly fix) the position of a stamp surface during the patterning process.

A particular advantage of the present invention is that the patterning process utilizes a flat stamp in a high-throughput manner. Not being bound by any particular theory, this permits a stamp to be produced in an inexpensive yet reproducible manner that does not require formation of a non-planar stamp surface, such as a cylinder, or another curved surface, that can be more difficult to manufacture than a stamp having a planar surface. An additional advantage of a planar stamp is that because there is no flexing or other distortion of the stamp surface during the patterning process there can be a reduced rate of registration errors and the like in the patterned product.

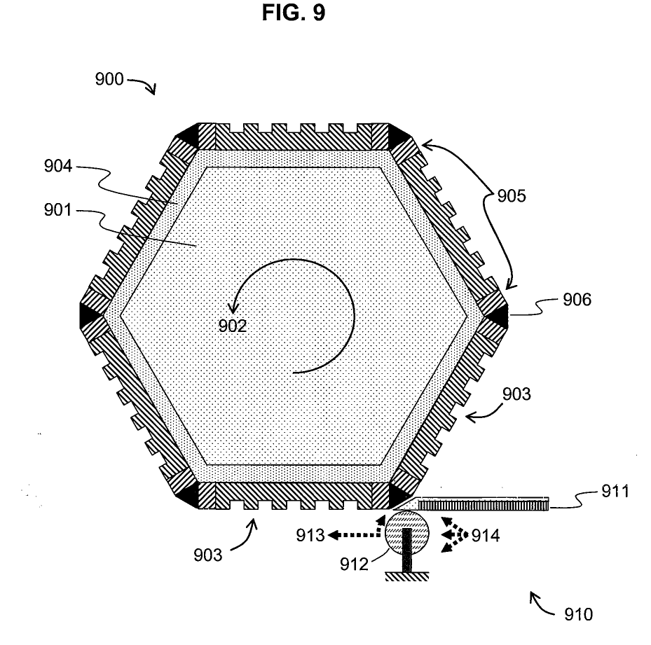

In some embodiments, it can be advantageous to employ a single stamp having multiple stamping surfaces. FIG. 9 provides a schematic cross-sectional representation of a multi-sided stamp suitable for use with the apparatus and process of the present invention. The multi-sided stamp, 900, comprise a rigid or semi-rigid inner member, 901, having at least n+1 sides, where n refers to the number stamping surfaces present on the multi-sided stamp. Stamping surfaces, 903, are mounted or otherwise attached to the inner member, 901, or an optional rigid mounting layer, 904. Optional support members, 905, and spacers, 906, can be present at the edges and corners of the stamping surface and multi-sided stamp, respectively. The multi-sided stamp rotates about an axis, 902, wherein for after each patterning process, the multi-sided stamp rotates Θ°, where Θ°=360°/n.

During a patterning process that uses a first stamp face of the multi-sided stamp, operations can be conducted on the remaining n−1 faces in preparation for a subsequent patterning operation. For example, FIG. 9 provides a schematic representation of an inking process, whereby a roller, 912, is contacted with an ink pad, 911, and then rolled across, 913, the face of a stamping surface, 903. During the inking operation an inert gas can be applied, 914, to the roller, stamping face, and combinations thereof, to assist in providing uniform inking of the entire stamp surface. Inking can also be performed by contacting an ink pad directly with the surface of a stamp, immersion inking, aerosol application of the ink to a stamp surface, by using an ink reservoir within the stamp (i.e., by which ink within the stamp is provided to the stamp surface via pores, microchannels, and the like), and combinations thereof.

In some embodiments, the rigid or semi-rigid inner member, 901, further comprises a porous and/or permeable reservoir suitable for containing an ink for use with the present invention. A reservoir can be filled with a volume of ink suitable for printing multiple patterns. By maintaining fluid communication between the reservoir and a surface of the stamp having a pattern therein, 903, the need to manually re-ink the stamp surface between printing operations is minimized. Materials suitable for use as a reservoir include, but are not limited to, porous elastomers, porous glasses, porous metals, metal wools and fibers, polymeric membranes, zeolites, and combinations thereof, and other porous materials known to persons of ordinary skill in the materials science art. In some embodiments, the reservoir comprises void space suitable for filling with a volume of ink, wherein the surface of the void is lined with a porous material suitable for absorbing the ink and promoting fluid communication between the porous reservoir and the stamp surface. In some embodiments, the reservoir comprises a pump suitable for delivering a controlled amount of an ink to a back surface of a stamp at a controlled interval, wherein upon delivery of the ink to the back surface of the stamp the ink diffuses through the stamp to the surface. Other methods of delivering a controlled amount of an ink to a surface of the stamp can include a microfluidic device, a device using capillary action, and the like, and combinations thereof.

Stamps and faces of multi-sided stamps can also be individually pre-treated, cleaned, and the like prior to or subsequent to inking of the stamp surface. In some embodiments, these processes can also be performed on the surface of a substrate before or after patterning. In some embodiments, the surface of a material and/or the surface of a stamp can be selectively patterned, functionalized, derivatized, textured, or otherwise pre-treated. As used herein, “pre-treating” refers to chemically or physically modifying a surface prior to applying an ink to a stamp or contacting a substrate with a stamp. Pre-treating can include, but is not limited to, cleaning, oxidizing, reducing, derivatizing, functionalizing, and exposing a surface to a reactive gas, plasma, thermal energy, ultraviolet radiation, and combinations thereof. Not being bound by any particular theory, pre-treating a surface of a stamp or a flexible substrate can increase or decrease an adhesive interaction between an ink and a surface, and facilitate the formation of a pattern on the surface of a flexible material.

For example, derivatizing a surface of a stamp with a polar functional group (e.g., oxidizing the surface of a stamp) can promote the wetting of a surface by a hydrophilic ink and deter surface wetting by a hydrophobic ink. Moreover, hydrophobic and/or hydrophilic interactions can be used to prevent an ink from penetrating into the body of a stamp. For example, derivatizing the surface of a stamp with a fluorocarbon functional group can facilitate the transfer of an ink from the stamp to the surface of a flexible substrate.

### The Rigid or Semi-rigid Member

The rigid or semi-rigid member provides a force suitable for contacting a flexible substrate with a stamp surface. Rigid or semi-rigid members for use with the present invention typically have at least one linear axis having a length at least as equal or greater to that of the width of the flexible substrate, and the width of a surface of a stamp suitable for patterning the flexible substrate. In addition to a linear axis, a rigid or semi-rigid member can have a secondary shape that can be modified to affect the interaction between the rigid or semi-rigid member and the backside of the flexible substrate, and to optimize contact of the flexible substrate with the surface of the stamp. For example, in some embodiments the ridge member has a secondary shape that is circular (i.e., the rigid or semi-rigid member is cylindrical), trigonal, rectangular, square, or polygonal. When the secondary shape of a rigid or semi-rigid member is non-circular, then it can be possible to utilize one or more edges of the rigid or semi-rigid member to accentuate contact between the flexible substrate and the surface of the stamp.

In some embodiments, a rigid or semi-rigid member further comprises an optional padded layer, or sheath, that surrounds the rigid or semi-rigid member. The padded layer surrounding the rigid or semi-rigid member can reduce damage to one or both of the backside of the flexible substrate and the stamp surface during processing.

In some embodiments, the motion of a rigid or semi-rigid member can be controlled by an x-y axis manipulator such as, for example, a stepper motor, interfaced with a microprocessor.

In some embodiments, a single rigid or semi-rigid member can be used to contact a flexible substrate with a surface of a stamp in combination with gravity, a vacuum applied between the face of the stamp and the flexible substrate, an adhesive force between the face of the stamp and the flexible substrate (i.e., provided by an ink), and combinations thereof.

Not being bound by any particular theory, the apparatus including a rigid or semi-rigid member minimizes distortions in both the stamp and the flexible substrate so that the patterning process is reproducible. As used herein, “reproducibility” refers to minimizing variability in the pattern from surface area-to-surface area across a single flexible substrate, minimizing variability in the pattern run-to-run (i.e., between different substrates patterned with the same stamp), and combinations thereof. Specifically, the apparatus including a rigid or semi-rigid member permits the angle of contact between the substrate and the stamp to be held constant across the surface of the stamp while minimizing distortions in the surface of the stamp.

### Additional Processes

In some embodiments, it is possible to integrate the patterning process with an additional process such as, but not limited to, pre-treating the substrate, blanket deposition on the substrate, self-aligned deposition on the substrate, etching of the substrate, and combinations thereof.

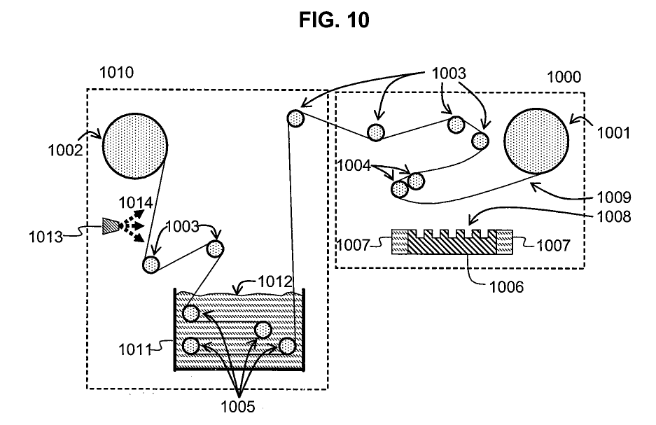

FIG. 10 provides a schematic cross-sectional representation of an apparatus suitable for patterning a substrate by a contact printing process followed by etching the flexible substrate. A first section of the apparatus, 1000, comprises a supply reel, 1001, that feeds a flexible substrate, 1009, around one or more rigid or semi-rigid members, 1004, and one or more rotating transit rollers. The rigid or semi-rigid members are positioned proximate to a stamp, 1006, having a stamping surface with at least one indentation therein, 1008, and optional rigid or semi-rigid support members, 1007, adjacent to the stamp.

A second section of the apparatus, 1010, comprises a collector reel, 1002, and one or more transit rollers, 1003. The flexible substrate, 1009, is passed through an etching bath, 1011, containing an etching solution, 1012. The etching time is determined by the number and position of etch-resistant rotating elements, 1005, positioned within the etching bath, as well as the feed rate of the substrate. Optionally, an additional intermediate collector reel can be placed between the first and section sections of the apparatus to decouple the printing rate from the etching rate, so that the processes can be performed on the same flexible substrate in a completely decoupled manner. For wet-etching operations, a drying element, 1013, can be positioned between the etching bath and the collector reel to provide an inert gas to one or both surfaces of the flexible substrate in preparation for collection of the substrate on the collector reel.

In some embodiments, a blanket and/or self-aligned deposition can be performed on the substrate after patterning using for example, an atmospheric plasma, an aerosol, a second contact printing apparatus, and the like. A self-aligned deposition process can use the hydrophilic, hydrophobic, and/or chemical properties of the patterned layer on the flexible substrate to induce selective deposition on either the patterned or unpatterned areas.

In some embodiments, either the entire apparatus or a portion thereof can be contained within a controlled environment. For example, the levels of particulates, oxygen, pressure, and the like can be controlled by placing the apparatus or the printing portion thereof in an enclosed environment. The control of particulates and the like can be a critical element in providing reproducible patterning of surfaces at the millimeter to sub-micron length scale.

### EXAMPLES

### Example 1

A flexible substrate, gold-coated poly(ethylene)naphthalene (“PEN”) was patterned using hexadecanethiol ink using a reel-to-reel apparatus. Briefly, ink was applied to a hard roller by traversing the hard roller over an ink-soaked pad. A nitrogen stream was applied to the roller to dry the ink while the roller traversed the face of the ink-soaked pad. Then the inked hard roller was then traversed across the face of a clean PDMS stamp to transfer the ink uniformly from the hard roller to the stamp.

The stamp was positioned proximate to two cylindrical rigid members having polyurethane padding sheaths. The two rigid members were moved to bring the flexible gold-coated PEN substrate into contact with the stamp while a supply reel supplied fresh substrate. One of the rigid members traversed the face of the stamp, thereby applying the substrate onto the stamp during this process. The other rigid member and the collector reel were held fixed to prevent movement of the substrate during the contact process. Both rigid members were then held in fixed positions for 1 to 20 minutes to permit the ink to transfer from the stamp to the substrate. The positive tension was then applied to the collector reel begin collection of the patterned substrate. Simultaneous to this, the rigid member that did not yet traverse the face of the stamp was moved towards the other rigid member while the collector reel continued to collect the flexible substrate. After meeting one another, the rigid members were moved away from the face of the stamp, while the collector reel continued to collect the flexible substrate. Both the rigid members were then returned to their original positions. The stamping cycle was completed by transferring the stamp out of the patterning station and replacing it with a freshly inked stamp.

### CONCLUSION

These examples illustrate possible embodiments of the present invention. While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

What is claimed is:

1. An apparatus for patterning a flexible substrate in a continuous manner, the apparatus comprising:
(a) a supply reel adapted to provide a flexible substrate;
(b) a stamp having a surface including at least one indentation therein, the indentation being contiguous with and defining a pattern in the surface of the stamp;
(c) a rigid or semi-rigid member adapted to contact a surface of the flexible substrate parallel to a plane of the surface of the stamp, wherein the stamp is adapted to remain stationary during contact; and
(d) a collector reel adapted to receive the flexible substrate.

2. The apparatus of claim 1, wherein the stamp comprises a plurality of surfaces.

3. The apparatus of claim 2, wherein the plurality of surfaces comprise identical patterns.

4. The apparatus of claim 2, wherein the plurality of surfaces comprise heterogeneous patterns.

5. The apparatus of claim 1, wherein the stamp is provided on a rotatable platform having an axis of rotation that is parallel, perpendicular, or skewed relative to a plane of a surface of the stamp.

6. The apparatus of claim 1, further comprising a reactor adapted for exposing a surface of the stamp to a reagent chosen from: radiation, thermal energy, a liquid reagent, a gaseous reagent, a plasma, and combinations thereof.

7. The apparatus of claim 1, wherein the rigid or semi-rigid member comprises two or more independently movable members.

8. The apparatus of claim 1, further comprising: an inking means adapted to apply an ink to at least one of: the surface of the stamp including at least one indentation therein, the frontside of the flexible substrate, and combinations thereof.

9. The apparatus of claim 1, further comprising: an aligning means adapted to align a location on a surface of the flexible substrate with a location on the surface of the stamp including at least one indentation therein.

10. An apparatus for patterning a flexible substrate, the apparatus comprising:
(a) a stamp having a surface including at least one indentation therein, the indentation being contiguous with and defining a pattern in the surface of the stamp;
(b) a flexible substrate adapted to contact the stamp when the flexible substrate is positioned between a supply reel and a collector reel; and
(c) a movable rigid or semi-rigid member adapted to apply a force to a location at a backside of the flexible substrate when the flexible substrate is in contact with the surface of the stamp, and when the stamp is rigidly positioned to thereby produce an ink pattern on a frontside of the flexible substrate, wherein the pattern in the surface of the stamp defines a lateral dimension of the ink pattern on the frontside of the flexible substrate.

11. The apparatus of claim 10, further comprising: an inking means adapted to apply an ink to at least one of: the surface of the stamp including at least one indentation therein, the frontside of the flexible substrate, and combinations thereof.

12. The apparatus of claim 10, further comprising: an aligning means adapted to align a location on a surface of the flexible substrate with a location on the surface of the stamp including at least one indentation therein.

13. A method for patterning a flexible substrate, the method comprising:
(a) providing a stamp having a surface, wherein the surface includes at least one indentation therein, the indentation being contiguous with and defining a pattern in the surface;
(b) contacting a flexible substrate with the surface of the stamp while the flexible substrate is positioned between a supply reel and a collector reel, wherein the surface of the stamp is stationary during the contacting;
(c) applying a force to a location at a backside of the flexible substrate during at least a portion of the contacting between the flexible substrate and the surface of the stamp, wherein applying the force transfers a pattern from the surface of the stamp to produce an ink pattern on a frontside of the flexible substrate, wherein the ink pattern on the frontside of the flexible substrate has a lateral dimension defined by the pattern in the stamp; and
(d) moving the location at which the force is applied at the backside of the flexible substrate.

14. The method of claim 13, further comprising: applying a tension to at least one of the supply reel, the collector reel, or both to shift the position of the flexible substrate, and repeating operations (b) through (d).

15. The method of claim 13, further comprising: before contacting the flexible substrate with the surface of the stamp, performing at least one of: pre-treating the surface of the stamp, pre-treating a surface of the flexible substrate, or a combination thereof.

16. The method of claim 13, further comprising: before contacting the flexible substrate with the surface of the stamp, performing at least one of: applying an ink to the surface of the stamp, applying an ink to the surface of the flexible substrate, or a combination thereof.

17. The method of claim 13, further comprising: aligning a surface of the flexible substrate with the surface of the stamp having at least one indentation therein.

18. The method of claim 13, further comprising using a rigid or semi-rigid member to apply the force.

19. The method of claim 18, wherein the rigid or semi-rigid member comprises a roller.

20. The method of claim 18, wherein the rigid or semi-rigid member comprises two or more independently controlled rigid members.

21. The method of claim 13, further comprising: producing a feature on an exposed surface of the flexible substrate defined by the pattern.
